(19) United States
(12) Patent Application Publication
(10) Pub. No.: US 2009/0275306 A1
(43) Pub. Date: Nov. 5, 2009

(54) Method and Apparatus for Showing Images During Radio Playback

(76) Inventors: Christian R Kraft, Frederiksberg (DK); Peter D. Nielsen, Kgs Lyngby (DK)

Correspondence Address: HARRINGTON & SMITH, PC, 4 RESEARCH DRIVE, Suite 202, SHELTON, CT, 06484-6212, US

(21) Appl. No.: 12/226,337

(22) PCT Filed: May 1, 2006
(86) PCT No.: PCT/IB2006/001103

§ 371 Date: Oct. 15, 2008

(51) Int. Cl. H04H 40/00

(52) U.S. Cl. 455/344

(57) ABSTRACT

A broadcast radio event, such as a song, and a plurality of radio data fields corresponding to the event, such as certain text radio data system RDS fields, is received at a broadcast radio receiver device. At least one radio data field is compared to image identifiers stored locally in the broadcast radio receiver. If a match is found between the at least one radio data field and an image identifier, a locally stored image associated with the matching image identifier is displayed at a local graphical display of the broadcast radio receiver device. If no locally stored matching image is found, an external database may be searched similarly and a non-local matching image is displayed. Various rules for matching are disclosed, as are an apparatus and a computer program product. The selected image may also be displayed alongside other radio data fields as text.

### TECHNICAL FIELD

The present invention relates to broadcast radio such as within the AM or FM bands, and particularly relates to rendering a display at a broadcast radio receiver device based on (radio data system or RDS) information received over a broadcast radio channel.

### BACKGROUND

Recent developments in licensing of digital versions of copyrighted music, and the accompanying portable music players that store them, has spurred an explosion in commerce for digital music. Consequently, many other portable multi-functional devices such as mobile stations and laptop computers are adapted for storing and playing digital music.

Broadcast radio has adapted to this explosion in digital music by adding RDS information to its broadcasts. The term broadcast radio is used herein consistent with its normal understanding, a wireless transmission intended for public reception, rather than a point to point message. Subscription-based satellite radio broadcasts are also considered broadcast radio, especially where a satellite radio network uses terrestrial repeaters to reach radio receivers. Radio Data System RDS is text and data transmitted with a broadcast radio signal by radios with an RDS decode capability, which typically display some of the RDS information as text to a user.

There are fifty or more different RDS categories, including station name, program type or PTY flag (e.g., pop, rock, talk radio), travel announcement or TA flag, enhanced other networks or EON flag, alternative frequency or AF flag, time and date or CF flag, and radio text. The station name is generally eight digits maximum, such as “Jazz FM” or the actual station identifier (e.g., BBC4, WTIC). The TA flag can be switched on when a radio station starts a travel report, and switched off at the end, so that the user's RDS compatible radio receiver can switch to a station carrying travel news (or in a car, pause a cassette or a CD) when local travel news is broadcast, The EON flag allows an RDS radio receiver to know about other associated stations, so a radio can know that when listening to one program, it should keep an ear on another (local) station for relevant travel news. The AF flag contains information about the current station's other FM frequencies, so that the radio can switch to a better signal while driving. The CF flag carries the current date and time, which automatically resets the clock in RDS clock radios and updates for seasonal time changes.

The radio text information ‘scrolls’ across RDS radio displays, providing information that's sent from the radio station. When a compatible radio receiver is tuned to a broadcast radio station that broadcasts RDS information, the receiver is tuned to a broadcast event and displays on a graphical display interface certain of the RDS information as text, such as the station name, program type, or information about a song being played such as title, artist, and/or album. This is not normally fitted to an in-car radio, as it's seen as a distraction to drivers.

The original RDS was developed by the European Broadcast Union EBU in 1984. Amongst those skilled in the art, the features of RDS are known by a large number of abbreviations, such as PS (Program Service name), PTY (Program Type), AF (Alternative Frequency list) and ODA (Open Data Applications). A more detailed review of RDS and its latest advancement, Radiotext Plus, can be found in the specification entitled: “Radiotext plus (RTplus) Specification” (version 1.0), RDS Forum 2005 R05/036_{—}1. RTplus was jointly developed by the Westdeutscher Rundfunk WDR, Nokia Corporation and the Institut für Rundfunktecknik IRT.

### SUMMARY

The foregoing and other problems are overcome, and other advantages are realized, in accordance with the presently described embodiments of these teachings.

In accordance with one exemplary embodiment of the invention is a method for displaying an image. In the method, a broadcast radio event and a plurality of radio data fields corresponding to the event is received at a device. Then at least one radio data field is compared to image identifiers stored locally in the device. If a match is found (between the at least one radio data field and an image identifier), an image associated with the matching image identifier is displayed at a local graphical display of the device.

In accordance with another exemplary embodiment of the invention is a device for displaying an image that includes a graphical display screen and a broadcast radio receiver coupled to an antenna. The receiver is for receiving broadcast radio events and a plurality of associated radio data fields. The device further includes a memory for storing a plurality of images and a set of image identifiers associated with each image, and a processor, coupled to the radio receiver, the memory and the display screen. The processor is for comparing at least one of the plurality of radio data fields to at least one image identifier of each set, and if a match is found by the comparing, the processor is further for driving the display screen to display the image associated with the matched image identifier.

In accordance with another exemplary embodiment of the invention is a program of machine-readable instructions, tangibly embodied on an information bearing medium and executable by a digital data processor, to perform actions directed toward selecting a locally stored image for display. The actions include 1) determining a plurality of radio data fields corresponding to a received broadcast radio event; 2) comparing at least one radio data field to locally stored image identifiers; and 3) if a match is found between the at least one radio data field and a locally stored image identifier, selecting a locally stored image associated with the matching locally stored image identifier for display. The “received broadcast radio event” need not have been received in its entirety, but may be currently received while the above other actions occur so that the locally stored image is selected for display prior to the end of the broadcast radio event.

In accordance with another exemplary embodiment of the invention is an apparatus that includes means for locally storing a plurality of images and associated image identifiers such as a volatile computer readable storage media. The apparatus further includes means for receiving a broadcast radio event and a plurality of radio data fields corresponding to the event, such as an antenna coupled to a radio receiver. Further, the apparatus includes means, such as a processor, for comparing at least one radio data field to each of the plurality of locally stored image identifiers. The apparatus includes also means for displaying a locally stored image associated with an image identifier that matches the at least one radio data field, such as a display driver and a graphical display screen.

Further details as to various embodiments and implementations are detailed below.

### BRIEF DESCRIPTION OF THE DRAWINGS

The foregoing and other aspects of these teachings are made more evident in the following Detailed Description, when read in conjunction with the attached Drawing Figures, wherein:

FIG. 1 is a diagram showing the context of the invention, multiple mobile stations equipped to receive RDS radio broadcasts from a radio broadcaster.

FIGS. 2A-2B are schematic diagrams of a mobile station showing respectively relevant internal components and an exterior of a mobile station according to an embodiment of the invention.

FIG. 3 is a process flow diagram illustrating steps in executing an embodiment of the present invention.

FIG. 4 is an isolated view of a graphical display of the mobile station of FIGS. 2A-2B according to an embodiment of the invention.

### DETAILED DESCRIPTION OF EMBODIMENTS OF THE INVENTION

With the continuing decrease in the cost of computer storage has come an increase in multi-functionality of portable electronic devices. For example, certain portable MP3 devices have been enhanced as compared to their original music-only versions to store and display digital photos, and certain mobile stations are enabled to store and play MP3 and video files. In both, an image of an artist or album art is displayed simultaneous with the playing of an MP3 file corresponding to that image. The Nokia® N91 is one commercially available example. MP3 is but one digital file compression technique, but is used here generically to represent digital music files generally. End users appear to generally prefer seeing an image of the artist or album art while a song is being played. Exemplary embodiments of this invention enable the display of such images in correspondence with listening to RDS broadcast radio.

In view of the prior art detailed above, what is needed is a way to enhance the user's experience with a portable broadcast radio receiver. While displayed RDS information might be minimized or inhibited in an automobile, there is no concern for distractions with hand-held portable devices such as mobile stations. This invention is directed to enhancing the user experience with broadcast radio receivers, especially hand-held receivers.

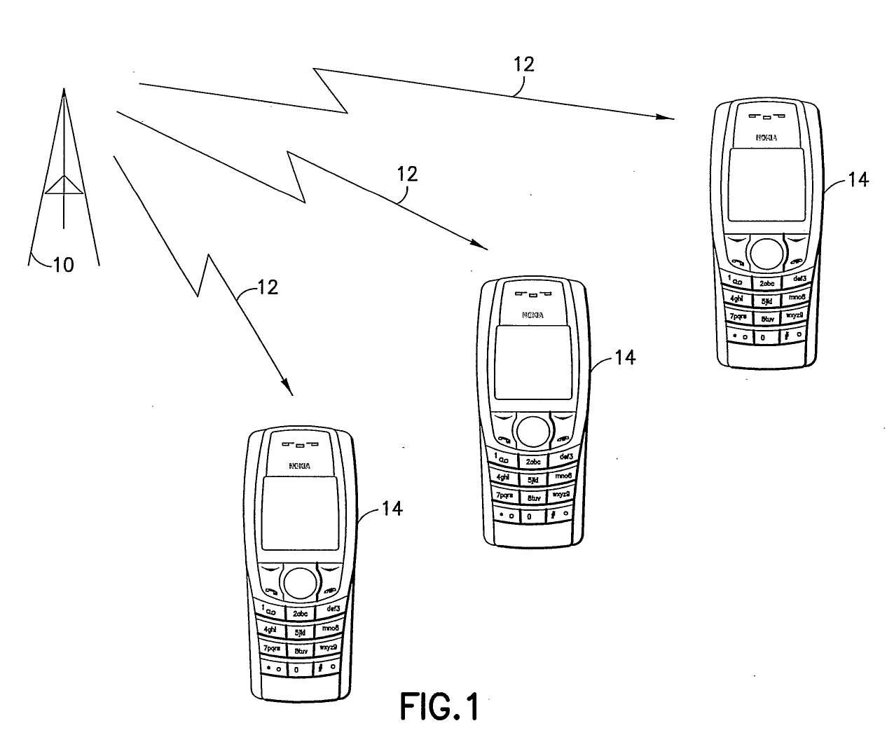

The environment in which the invention operates is shown in FIG. 1. A broadcast radio transmitter 10 provides a broadcast radio signal with RDS information over a unidirectional link 12 to a plurality of broadcast radio receivers, shown in FIG. 1 as mobile stations 14.

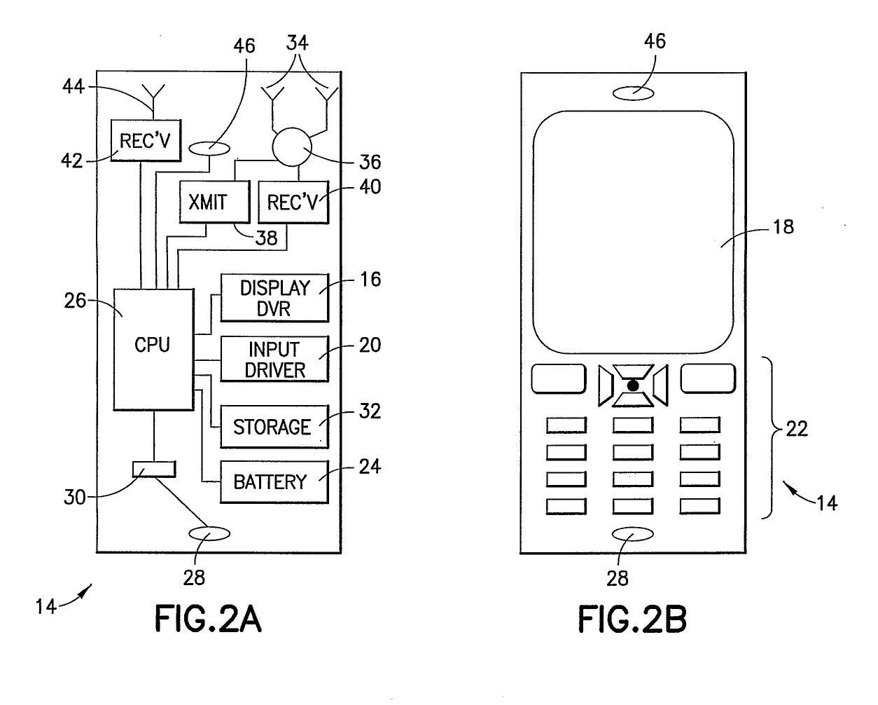

FIG. 2A illustrates a schematic diagram of major internal components of a mobile station MS 14 in which the invention may be embodied. The invention may be disposed in any host computing device having a graphical display element, a local storage, and a broadcast radio receiver adapted to decode RDS, whether or not the device is mobile, whether or not it is coupled to a cellular of other data network or even capable of communicating with other devices via a network. In FIG. 2A as a non-limiting example, the MS 14 is a handheld portable device that is capable of wirelessly accessing a communication network, such as a mobile telephony network of base stations that are coupled to a publicly switched telephone network. A cellular telephone, a portable email device, and a personal digital assistant (PDA) with Internet or other two-way communication capability are examples of a MS 14. A portable wireless device includes mobile stations as well as additional handheld devices such as broadcast radio receivers without disparate functionality. FIG. 2B illustrates exterior portions of the same MS 14.

The component blocks illustrated in FIGS. 2A-2B are functional and the functions described below may or may not be performed by a single physical entity as described with reference to FIGS. 2A-2B. A display driver 16, such as a circuit board for driving a graphical display screen 18, and an input driver 20, such as a circuit board for converting inputs from a keypad array 22 of user actuated buttons, joystick, and/or touch sensitive pad to electrical signals, are provided with the display screen 18 and keypad array 22 for interfacing with a user. The input driver 20 may also converts user inputs at the graphical display screen 18 when that display screen 18 is touch sensitive, as known in the art. The MS 14 further includes a power source 24 such as a self-contained battery that provides electrical power to a central processor unit CPU 26. The CPU or processor 26 controls functions within the MS 14. Within the processor 26 are functions such as digital sampling, decimation, interpolation, encoding and decoding, modulating and demodulating, encrypting and decrypting, spreading and despreading (for a CDMA compatible MS 14), and additional signal processing functions known in the art.

Voice or other aural inputs are received at a microphone 28 that may be coupled to the processor 26 through a buffer memory 30. Computer programs such as algorithms to modulate, encode and decode, data arrays such as look-up tables, and the like are stored in a main memory storage media 32 which may be an electronic, optical, or magnetic memory storage media as is known in the art for storing computer readable instructions and programs and data. The memory storage media 32 further stores audio files such as MP3 files, and associated data such as song title, artist, album art images, and artist images as known in the art. The main memory 32 is typically partitioned into volatile and non-volatile portions, and is commonly dispersed among different storage units, some of which may be removable. The MS 14 communicates over a network link such as a mobile telephony link via one or more cellular antennas 34 that may be selectively coupled via a T/R switch 36, or a diplex filter, to a network transmitter 38 and a network receiver 40. The MS 14 further includes a broadcast radio receiver 42 coupled between the processor 26 and a broadcast radio antenna 44 that is particularly adapted to receive broadcast signals such as FM and AM. A single antenna may be resonant at multiple frequencies, and thereby serve as both the cellular antenna 34 and the broadcast radio antenna 44, as is known in the art. A RDS decoder may be embodied in the broadcast radio receiver 42, in the processor 26, or as decoding software stored in the memory 32 and executed by the processor 26.

The MS 14 may additionally have tertiary transmitters and receivers for communicating over additional networks, such as a WLAN, WIFI, Bluetooth®, or to receive digital video broadcasts. Known antenna types include monopole, di-pole, planar inverted folded antenna PIFA, and others. The various antennas may be mounted primarily externally (e.g., whip) or completely internally of the MS 14 housing as illustrated. Audible output from the MS 14 is transduced at a speaker 46. Most of the above-described components, and especially the processor 26, are disposed on a main wiring board (not shown). Typically, the main wiring board includes a ground plane to which the antenna(s) 34, 44 are electrically coupled.

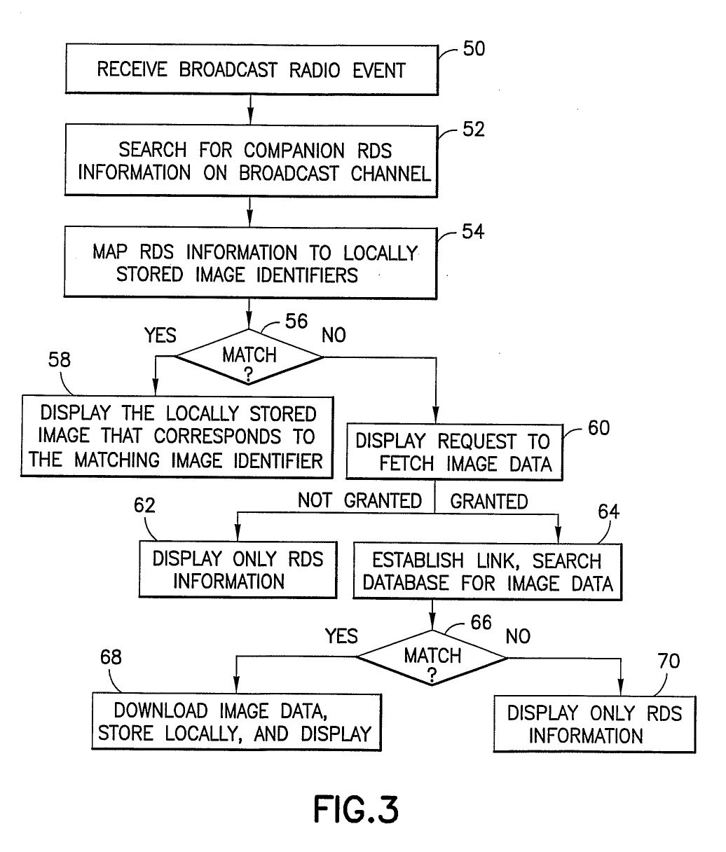

FIG. 3 illustrates in process step diagram form an embodiment of the invention. A broadcast radio event is received at block 50. A broadcast event may be any discrete radio broadcast, including a song, an advertisement, a monologue, etc. The radio receiver then searches, at block 52 if necessary, for radio data fields corresponding to that event. In RDS, the data fields are detailed in the background section. Note that not all radio data fields of RDS correspond to a particular broadcast event. At least the EON flag, the AF flag, and the CF flag are unrelated to any particular broadcast of content, so are not associated with a broadcast radio event. Typically, RDS information is broadcast simultaneous with, and on the same (frequency modulated) channel, as the radio event. In some embodiments it is contemplated that radio data fields may be broadcast on a side channel separate from the radio event. In an advantageous implementation, only the radio text fields of RDS (or similar fields that relay song title, artist, and/or album of a song being currently broadcast) are used in the invention so as to avoid non-productive comparisons.

Once the radio data fields are obtained for the currently-playing (tuned to) radio event, at least one radio data field is mapped or compared at block 54 to image identifiers that are stored locally in the broadcast radio receiver. Image identifiers may be, as non-limiting examples, keywords, titles, or other identifying indicia of a locally stored image (e.g., a .jpg file, a .pdf file). The image identifiers do not form a portion of the content of the locally stored image in much the same way that radio data fields do not form a part of the content of the radio event that they describe. Block 56 becomes active and asks whether a match has been found, detailed further below. If a match is found between the compared radio data field and an image identifier, then at block 58 the locally stored image associated with the matching image identifier is displayed at a graphical display screen 18.

If no match is found within the local memory of the device, then embodiments of the invention may display a request at block 60 to attempt to locate image data corresponding to the broadcast radio event (and its corresponding RDS information) outside the device, such as within one or more designated external databases or a search of the entire Internet (e.g., using a commonly available search engine). If the user fails to grant that displayed request, such as by positively responding in the negative or failing to register a response within a certain period of time, then at block 62 the radio data fields are displayed as text at the display screen 18. In embodiments that do not include the external search option, then the lack of a match at block 56 leads directly to block 62.

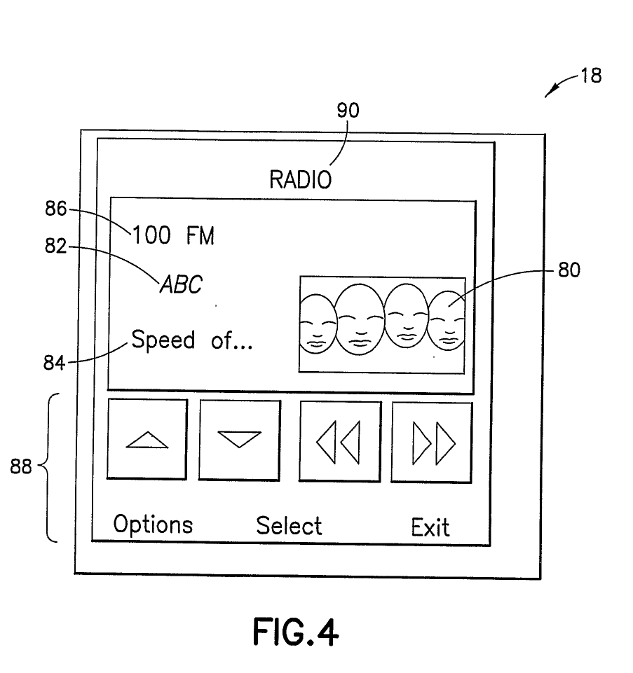

If instead the user does grant permission to search for the corresponding image data outside the portable device, then at block 64 the device establishes a link, via a wireless network, to the designated database(s) (e.g., that database that the host device lists as its default site for music downloads) or to an Internet search engine where the database is to be the whole Internet. The wireless network may be a general packet radio service GPRS network, a wireless local area network WLAN, or any similar network appropriate for linking with a database of (at least) image data. At block 64, the device searches the database/Internet for corresponding image data, and the manner of search may use the same or different image identifiers as were used to search locally in block 54, or may use identifiers specifically tailored to the designated database(s) if only a designated database is to be searched. Additional search terms not particular to the radio event may also be used with the radio data field(s) in order to better focus the search, especially where block 64 accesses a generalized Internet search engine. For example, the term “album art” may be used in addition to one or more radio data fields to better constrain the search engine's task to the desired result. The search of a non-local database, designated or otherwise, may be an iterative process since more than one “matching” result may be returned from the external database. In that instance, then either the multiple “matches” of an initial search are individually processed further in FIG. 4 (perhaps in order of relevance, a term of art used in the digital searching arts), or the initial search is successively narrowed with additional search terms/radio data fields until only one result remains for further processing in FIG. 4.

Regardless of how a single image data file is selected from an external database, at block 66 it is determined if that particular single image data file from the non-local database matches the radio data fields, as was done in block 56 and detailed below. If a match is found, then at block 68 the matching image data file from the external database is downloaded, stored in a local memory, and displayed. This storage may be only temporary as in a cache memory, or more permanent as in a main memory with other image data that is not generally overwritten without user approval. If no match is found at block 66 within the searched non-local database(s), then at block 70 the radio data fields are displayed as text at the display screen 18 (similar to that done at block 62).

Where a song is stored as an MP3 (or other compression) file within a local memory of a radio receiver device, or within a non-local database searched as described at FIG. 3, it may be stored with associated information such as song title, album and track number, artist, an image of album art or the artist/band image. Consider these as image identifiers, because as a set they identify only one image, the album art or artist image. A match between the radio data fields and the image identifiers may be according to a hierarchical order, such as first checking for an exact match between a set of several radio data fields and a set of image identifiers. If in fact no exact match occurs, then the best match may be selected (e.g., matching two out of four radio data fields to two image identifiers, where all other sets match less than two). In certain embodiments, matching only a single one of the radio data fields to an image identifier will match an image for display that corresponds to the single matching image identifier. For example, if the radio receiver device has stored locally a single song from the band ABC, and it receives a radio event of a different ABC song from a different album, then a comparison of radio data fields [song title, artist, album] will return the single locally stored ABC song whose image identifier matches the data field [artist]. In that instance, the image associated with that different locally stored song may be displayed when the other broadcast ABC song is being played on the broadcast radio receiver. This is seen as preferable to most end users over no image being displayed at all, even if the image is album art from a different ABC album.

In the event that whatever matching rules are in effect find no satisfactory match between radio data field and image identifier, then the radio data fields used in the search can be merely displayed as text as is currently the case. The difference being that with this invention, the text display occurs only after an unproductive search of locally stored images and their associated image identifiers.

The end result of a positive match at blocks 56 or 66 of FIG. 3 and completion of blocks 58 or 68 is shown in FIG. 4, a detailed view of the display screen 18 of the device of FIG. 2B. The image 80 from the local or non-local memory that was selected after a successful search and comparison is shown on the display 18. Also shown as text is a first radio data field [artist] 82 and a second radio data field [song title] 84, which in this instance were used in the search. Note that in the above description, even if only one radio data field was used to select an image 80 by matching only one image identifier (e.g., more likely in the search of local memory), more than that single radio data field may be displayed as text on the display because the radio data fields are over-the-air broadcasts associated with the song being played, so they each match the song even if not every one of them matches the locally stored image 80. The same is true for an image returned from a non-local search, but less likely. Also displayed as text in FIG. 4 is a third radio data field [station identifier] 86 that is not tied directly to the particular radio event song being played. From internal of the device and not associated with the broadcast is displayed an options menu 88 and an output mode 90 for user convenience. These additional displays of radio data fields as text apart from the image 80 are optional; the image 80 may be displayed to occupy essentially the entire viewing display screen 18 in certain embodiments, or only a portion thereof as shown in FIG. 4.

The search process of FIG. 3 may be made more efficient by searching by some grouping parameter, at least initially. For example, if the device has stored on it MP3 files with associated images a well as images not associated with MP3 files, only those image identifiers associated with images for MP3 files need be searched. The same may be accomplished in the non-local search, where the grouping parameter(s) may be the additional search terms such as “album art” noted above. This saves some processing power and conserves some battery life in a portable device.

As compared to the prior art, it is clear that use of the exemplary embodiments of this invention enables the showing of an appropriate image at a display of a broadcast radio receiving device when simultaneously receiving (tuned to) a song or other audio radio event. Current RDS provides only text information, so the present invention exploits images that are locally stored or accessible via a wireless link to display simultaneous with playing of a song received on a broadcast receiving device. Note that RDS may be but one of several approaches for providing radio data fields, and the invention is not limited only to RDS. Preferably, once the radio event that bears the radio data fields used to match and select an image 80 terminates, the image 80 is removed from the display screen 18. Alternatively, the image 80 may remain displayed until either the receiver is changed to another channel, the device is tuned off (or only the broadcast radio receiver is turned off, if the device is a multi-function device such as a radio-enabled mobile station), or another match (or an unsuccessful search) results from a new radio event with new radio data fields. In the latter embodiment, it may be that an image 80 remains displayed even through an advertisement (that does not carry associated radio data fields) intervening between radio song events. If a search of image identifiers by radio data fields finds no match, the radio data fields (one or more of them) used in the search may be displayed as text on the device display screen, in place of an image.

The device may continuously scan for new radio data fields and compare when a new set is found, it may continually compare currently received radio data fields against image identifiers, or it may periodically do either. Most efficiently, the device can continuously or periodically scan for a change to a particular radio data field to change, such as [title]. The device may be adapted to facilitate the comparing and selecting described above by having images grouped into an assortment that is either first searched or solely searched for purposes of displaying with broadcast radio events. For example, users may mark individual images with a tag ‘favorite artist’ or the like, and the processor would then search either solely or at least initially among those images tagged as ‘favorite artists’. Various other groupings will be obvious with ordinary skill in the art.

The embodiments of this invention may be implemented by computer software executable by a data processor of the mobile station 32 or other host device, such as the processor 40, or by hardware, or by a combination of software and hardware. Further in this regard it should be noted that the various blocks of the logic flow diagram of FIG. 4 may represent program steps, or interconnected logic circuits, blocks and functions, or a combination of program steps and logic circuits, blocks and functions.

The memory or memories 32 may be of any type suitable to the local technical environment and may be implemented using any suitable data storage technology, such as semiconductor-based memory devices, magnetic memory devices and systems, optical memory devices and systems, fixed memory and removable memory. The data processor(s) 26 may be of any type suitable to the local technical environment, and may include one or more of general purpose computers, special purpose computers, microprocessors, digital signal processors (DSPs) and processors based on a multi-core processor architecture, as non-limiting examples.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

It is noted that the teachings of the present invention may be extended to any device configured to receive radio broadcasts and associated radio data fields, including mobile stations, other hand-held devices, non-portable devices, and the like.

Although described in the context of particular embodiments, it will be apparent to those skilled in the art that a number of modifications and various changes to these teachings may occur. Thus, while the invention has been particularly shown and described with respect to one or more embodiments thereof, it will be understood by those skilled in the art that certain modifications or changes may be made therein without departing from the scope and spirit of the invention as set forth above, or from the scope of the ensuing claims.

What is claimed is:

1. A method for displaying an image comprising:
receiving at a device a broadcast radio event and a plurality of radio data fields corresponding to the event;
comparing at least one radio data field to image identifiers stored locally in the device; and
if a match is found between the at least one radio data field and an image identifier, displaying an image associated with the matching image identifier at a graphical display of the device.

2. The method of claim 1, wherein comparing comprises comparing at least two of the plurality of radio data fields against sets of image identifiers, each set of image identifiers associated with one locally stored image, and further wherein displaying comprises displaying a locally stored image whose associated set of image identifiers best match the at least two of the plurality of radio data fields.

3. The method of claim 1, wherein comparing comprises comparing at least two of the plurality of radio data fields against sets of image identifiers, each image identifier associated with one locally stored image, and further wherein displaying comprises displaying a locally stored image whose associated set of image identifiers identically match the at least two of the plurality of radio data fields.

4. The method of claim 1, further wherein if no match is found, displaying the at least one radio data field as text at a local graphical display of the broadcast radio receiver.

5. The method of claim 1, wherein the broadcast radio event comprises a song and the plurality of radio data fields comprise radio data system fields.

6. The method of claim 5, wherein the plurality of radio data fields comprise song title and artist.

7. The method of claim 1, wherein the device comprises a handheld portable device.

8. The method of claim 1, wherein the broadcast radio event and the plurality of radio data fields corresponding to the event are received over a frequency modulated channel.

9. The method of claim 1, further comprising:
if a match is not found between the at least one radio data field and an image identifier stored locally in the device, establishing a wireless link with an external database outside the device and searching the external database for an image associated with an image identifier that matches the at least one radio data field;
wherein displaying comprises displaying the image from the external database that is associated with the matching image identifier.

10. A device for displaying an image comprising:
a graphical display screen;
a broadcast radio receiver coupled to an antenna for receiving broadcast radio events and a plurality of associated radio data fields;
a memory for storing a plurality of images and a set of image identifiers associated with each image; and
a processor, coupled to the radio receiver, the memory and the display screen, for comparing at least one of the plurality of radio data fields to at least one image identifier of each set, and if a match is found by the comparing, for driving the display screen to display the image associated with the matched image identifier.

11. The device of claim 10, wherein the processor is for comparing at least two of the plurality of associated radio data fields against each set of image identifiers, and if a match is found, for driving the display screen to display the image associated with the set of image identifiers that best match the at least two of the plurality of radio data fields.

12. The device of claim 10, wherein the processor is for comparing at least two of the plurality of associated radio data fields against each set of image identifiers, and if a match is found, for driving the display screen to display the image associated with the set of image identifiers that identically match the at least two of the plurality of radio data fields.

13. The device of claim 10, wherein the plurality of associated radio data fields comprises song title and artist.

14. The device of claim 10, wherein the device comprises a handheld portable device.

15. The device of claim 10, further comprising a wireless transceiver and further wherein if a match is not found by the comparing, the processor drives the transceiver to send a wireless request to search an external database for a non-local image associated with an image identifier that matches the at least one of the plurality of radio data fields, and if the transceiver receives a positive response to the search request that identifies a particular image, the processor is further for downloading the particular image and for driving the display screen to display the particular image.

16. A program of machine-readable instructions, tangibly embodied on an information bearing medium and executable by a digital data processor, to perform actions directed toward selecting a locally stored image for display, the actions comprising:
determining a plurality of radio data fields corresponding to a received broadcast radio event;
comparing at least one radio data field to locally stored image identifiers; and
if a match is found between the at least one radio data field and a locally stored image identifier, selecting a locally stored image associated with the matching locally stored image identifier for display.

17. The program of claim 16, wherein comparing comprises comparing at least two of the plurality of radio data fields against locally stored sets of image identifiers, each set of image identifiers associated with one locally stored image, and further wherein selecting comprises selecting a locally stored image whose associated set of image identifiers best match the at least two of the plurality of radio data fields.

18. The program of claim 16, wherein comparing comprises comparing at least two of the plurality of radio data fields against locally stored sets of image identifiers, each set of image identifiers associated with one locally stored image, and further wherein selecting comprises selecting a locally stored image whose associated set of image identifiers identically match the at least two of the plurality of radio data fields.

19. The program of claim 16, further wherein if no match is found, selecting the at least one radio data field for display as text.

20. The program of claim 16, wherein the plurality of radio data fields comprise radio data system fields.

21. The program of claim 20, wherein the plurality of radio data fields comprise song title and artist.

22. The program of claim 16, wherein the information bearing medium is disposed within a mobile station.

23. The program of claim 16, wherein the actions further comprise:
if a match is not found between the at least one radio data field and a locally stored image identifier, establishing a link to an external database outside a device in which the information bearing medium is disposed, causing a search of the external database for an external image associated with an image identifier that matches the at least one radio data field, and if a match is found in the external database, selecting the external image for local storage and display.

24. An apparatus comprising:
means for locally storing a plurality of images and associated image identifiers;
means for receiving a broadcast radio event and a plurality of radio data fields corresponding to the event;
means for comparing at least one radio data field to each of the plurality of locally stored image identifiers; and
means for displaying an image associated with an image identifier that matches the at least one radio data field.

25. The apparatus of claim 24, wherein
the means for locally storing comprises a volatile computer readable storage media;
the means for receiving comprises an antenna coupled to a radio receiver;
the means for comparing comprises a processor; and
the means for displaying comprises a display driver and a graphical display screen.
